(19) United States
(12) Patent Application Publication
(10) Pub. No.: US 2022/0164891 A1
(43) Pub. Date: May 26, 2022

(54) System and Method for Coordinated Digital Collision Certificates

(71) Applicants: Salim Kara, North York (CA); Alnoor Kara, North York (CA)

(72) Inventors: Salim Kara, North York (CA); Alnoor Kara, North York (CA)

(73) Assignee: Kara Vault, Inc., North York (CA)

(21) Appl. No.: 17/532,600

(22) Filed: Nov. 22, 2021

Related U.S. Application Data
(60) Provisional application No. 63/198,976, filed on Nov. 26, 2020.

(51) Int. Cl. G06Q 40/08; G06Q 50/26; G08G 1/017

(52) U.S. Cl. CPC G06Q 40/08; G08G 1/017; G06Q 50/265

(57) ABSTRACT

There are provided systems and methods for generation of a collision certificate. The system including one or more processors configured to execute: an input module to receive collision-relevant information and collision information; a certificate module to generate the collision certificate including a license plate number, a picture of the user, and encoded data encompassing the collision information; a coordination module to receive the encoded data associated with another collision certificate associated with the one or more other drivers involved in the collision, the coordination module communicates the collision-relevant information associated with the user and the encoded data associated with the one or more other drivers to the server and receives a unique collision claim number, the unique collision claim number is associated with the collision-relevant information and encoded data from each driver involved in the collision; an output module to output the unique collision claim number.

### CLAIM OF PRIORITY AND CROSS-REFERENCE TO RELATED APPLICATION

The present application is related to U.S. Provisional Patent Application No. 63/198,976, filed Nov. 26, 2020, entitled “System and Method for Coordinated Digital Collision Certificates.” The present application hereby claims priority under 35 U.S.C. § 119(e) to U.S. Provisional Patent Application No. 63/198,976.

### BACKGROUND

When individuals are involved in an automobile accident, they are typically required to exchange information with each other for various purposes, for example, for reporting to a government agency or for making a claim to insurance. However, exchanging personal information after a collision is typically with a complete stranger, and is therefore unsecure and potentially risky. The stranger is given access to the other's driver license information, including home address and other identifiable information. Additionally, given that the other person is a stranger, the other driver does not know if that stranger has valid automobile insurance. Additionally, this exchange and reporting is often wasteful of time and resources for all parties involved.

### SUMMARY

There is provided a system and method for generation of a collision certificate associated with a vehicle collision. In an aspect, the system comprising one or more processors in communication with a data storage and a user interface, the system in communication with a server, the one or more processors configured to execute: an input module to receive, from a user, collision-relevant information associated with the user and collision information associated with the vehicle collision; a certificate module to generate the collision certificate, the collision certificate comprising a license plate number of the user's vehicle involved in the vehicle collision, a picture of the user, and encoded data encompassing the collision information, the certificate module displays the collision certificate via the user interface for verification of one or more other drivers involved in the collision; a coordination module to receive the encoded data associated with another collision certificate associated with the one or more other drivers involved in the collision, the coordination module communicates the collision-relevant information associated with the user and the encoded data associated with the one or more other drivers to the server and receives a unique collision claim number, the unique collision claim number is associated with the collision-relevant information and encoded data from each driver involved in the collision; and an output module to output the unique collision claim number to the user via the user interface.

These and other aspects are contemplated and described herein. It will be appreciated that the foregoing summary sets out representative aspects of embodiments to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a diagram of an operating environment for a system for coordinated digital collision certificates, according to an embodiment;

FIG. 2 is a diagram of the system for coordinated digital collision certificates. According to an embodiment;

FIG. 3 is a flowchart for a method for coordinated digital collision certificates, according to an embodiment;

FIG. 4 is an example of a screenshot for a digital collision certificate according to the system of FIG. 2; and

FIG. 5 is an example of a screenshot for a digital collision certificate, with a recording and uploading option, according to the system of FIG. 2.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to interpersonal information exchange systems; and more specifically to a system and method for coordinated digital collision certificates.

The present embodiments provide a safe and secure approach for immediate exchange of personal and insurance information between drivers involved in a collision at the location of the collision. Advantageously, the present embodiments ensure that personal information, that is required to be exchanged after a collision for collision reporting purposes, remains hidden from the other party.

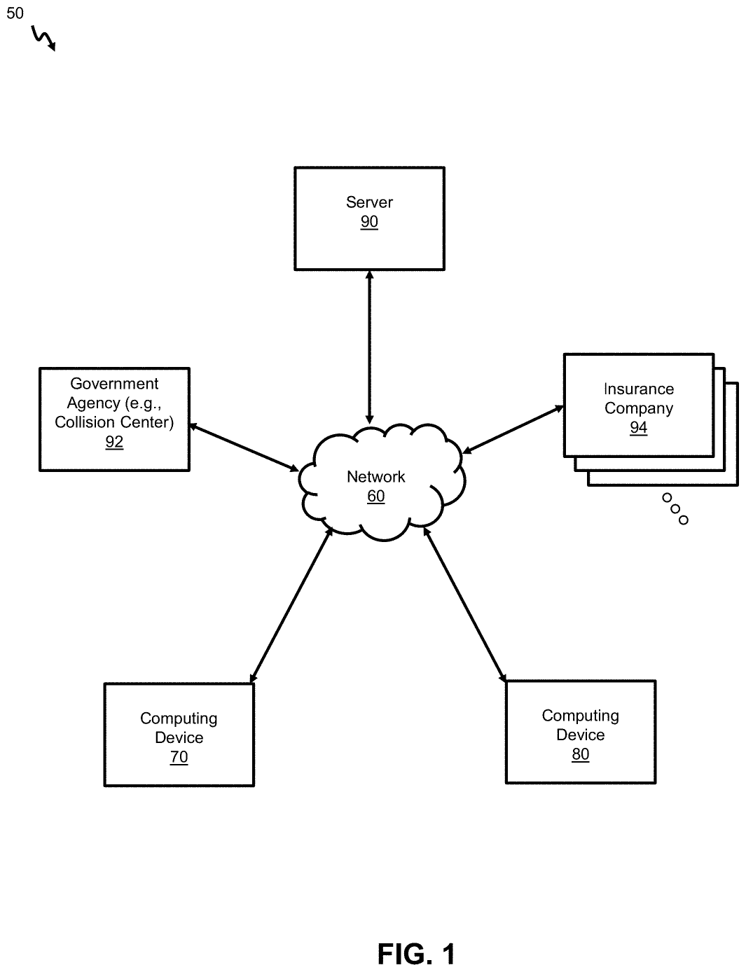

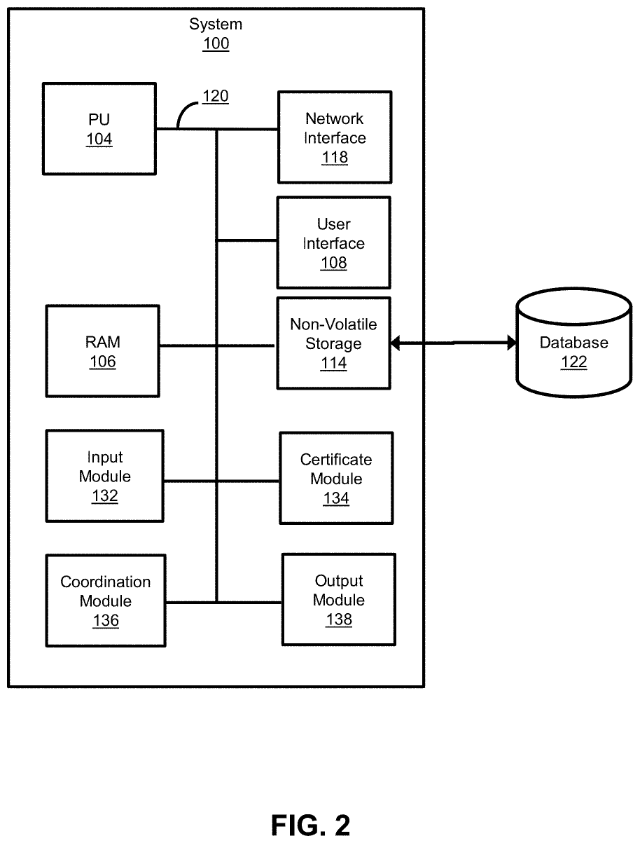

Referring now to FIGS. 1 and 2, a system for coordinated digital collision certificates 100, in accordance with an embodiment, is shown in the context of an operating environment 50. In this operating environment, two computing devices 70 and 80, such as two smartphones, are in communication with a server 90 over a network 60, such as the Internet. The communication over the network 60 can preferably use end-to-end encryption. The system 100 can be implemented on one or more of the devices in this operating environment 50. In this embodiment, each of the computing devices 70 and 80 are operated by a driver involved in the collision, and the server provides centralized processing and data storage. In further embodiments, other operating environments can be used; such as the two computing devices 70 and 80 communicating directly over the network 60, without the server 90 mediation, but with appropriate encryption and controls to ensure that the user is not exposed to certain identifying information as described herein.

In some cases, the server 90, the computing devices 70 and 80, or both, can communicate with other computing systems over the network 60; for example, a government agency 92 (such as a collision reporting center) and one or more insurance companies (such as the insurance companies associated with the drivers involved in the collision).

FIG. 2 shows various physical and logical components of an embodiment of the system 100. In some cases, the system can be part of a computing device, for example, a smartphone, tablet, laptop, desktop, or similar computing device. As shown, the system 100 has a number of physical and logical components, including a processing unit (“PU”) 104 (comprising one or more processors), random access memory (“RAM”) 106, a user interface 108, non-volatile storage 114, a network interface 118, and a local bus 120 enabling the PU 104 to communicate with the other components. RAM 106 provides relatively responsive volatile storage to PU 104. The user interface 108 enables an administrator or user to provide input via an input device, for example a keyboard and mouse, or a touchscreen. The user interface 108 can also output information to output devices to the user, such as a display, speakers, or touchscreen. The network interface 118 permits communication with other systems, such as other computing devices or the server 90 over the network 60. Non-volatile storage 114 stores the operating system and modules, including computer-executable instructions for implementing the operating system and modules, as well as any data used by these services. Additional stored data can be stored in a database 122. During operation of the system 100, the operating system, the modules, and the related data may be retrieved from the non-volatile storage 114 and placed in RAM 106 to facilitate execution.

The system 100 further includes a number of conceptual modules that can be executed on the PU 104; in an embodiment, an input module 132, a certificate module 134, a coordination module 136, and an output module 138. In some embodiments, the modules of the system 100 are stored by and executed on a single computing device. In other embodiments, the modules of the system 100 can be distributed among two or more computing devices that may be locally or remotely distributed; for example, some functions of the modules can be executed on the server 90 or other computing device. In some cases, the functions and/or operations of the modules can be combined or executed on other modules.

In an embodiment, advantageously, the only information available to each of the users is a photo of the other driver, their license plate number, and a Quick Response code (QR code). The QR code encodes a make, model, and color of the other driver's vehicle, the other driver's driving-license number, and insurance information (for example, company and policy number). Advantageously, none of this accessible information about the other driver can generally be used to compromise their personal security.

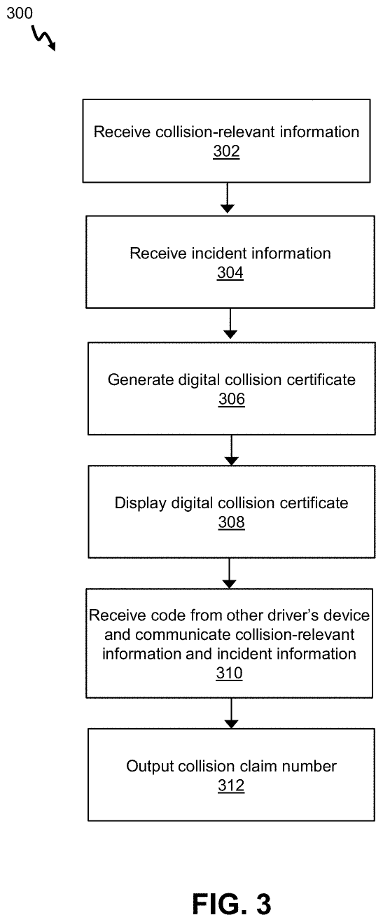

Referring now to FIG. 3, a method for coordinated digital collision certificates 300, in accordance with an embodiment, is shown.

At block 302, the input module 132 receives from the user, via the user interface 108, collision-relevant information. Such collision-relevant information can include, for example, their name, address, email address, make, model, and color of their vehicle(s), insurance information (for example, insurance provider name, address, and policy number), and the like. In some cases, the above information is also added for any additional drivers authorized to drive the vehicle(s) on the user's insurance policy. In some cases, the user can also input biometric identifiers, such as via a fingerprint reader on a smartphone. In some cases, the user can also include a picture of themselves and a picture of any other drivers authorized to drive the vehicle(s) on the user's insurance policy.

After a collision occurs, at block 304, the input module 132 receives from the user, via the user interface 108 on their respective computing device 70, 80, incident information. The incident information includes, for example, selecting their name as the driver that was driving the vehicle and selecting the particular vehicle they were driving. The other driver likewise inputs incident information on their respective computing device 70, 80.

At block 306, the certificate module 134 generates a collision certificate (referred to as a digital collision certificate (DCC)). In a particular case, the DCC comprises the license plate number of the selected vehicle, the picture of the driver, and a QR code. In an example, the QR code encodes a make, model, and color of the selected vehicle, the driving-license number of the selected driver, and insurance information associated with the selected driver (for example, insurance company and policy number). The respective computing device 70, 80 of the other driver likewise generates a DCC.

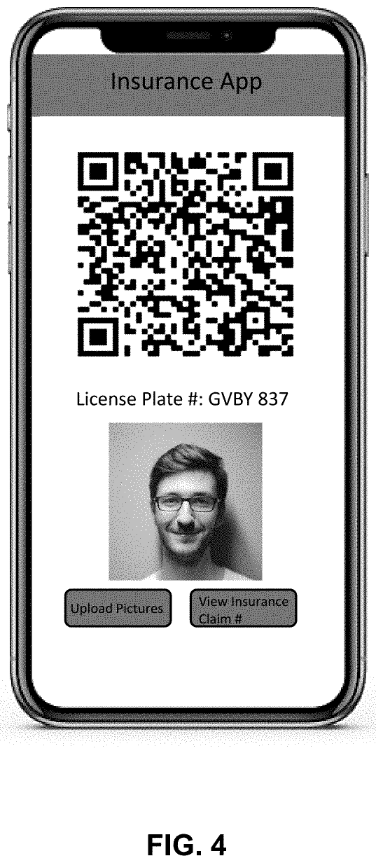

At block 308, the certificate module 134 displays the DCC on the respective computing device 70, 80 via the user interface 108. In the above case, the license plate number, the picture of the driver, and the QR code are displayed. An example of which is illustrated in FIG. 4. The respective computing device 70, 80 of the other driver likewise displays the other respective DCC.

Each party then visually inspects and verifies that the other drivers have created a valid DCC by ensuring that the picture and license plate number being displayed on the other driver's respective computing device 70, 80 match the other driver. Once both parties agree to the match, at block 310, the coordination module 136 captures the QR code displayed on the other driver's respective computing device 70, 80 and communicates the collision-relevant information and the data encoded by the QR code of the other driver to the server 90. The server 90 can take the collision-relevant information and the data encoded by the QR code, from each driver, and associate a unique collision claim number associated with the particular collision. The server 90 communicates the unique collision claim number with the coordination module 136. In some cases, the server 90 can communicate at least some of the collision-relevant information, the data encoded by the QR code associated with each driver, and the unique collision claim number to the government agency 92 and/or one or more of the insurance companies 94.

At block 312, the output module 138 can output to the user, via the user interface 108, that the collision claim number was generated successfully. Once the unique collision claim number has been associated, any further information or follow-up can be easily associated with this number.

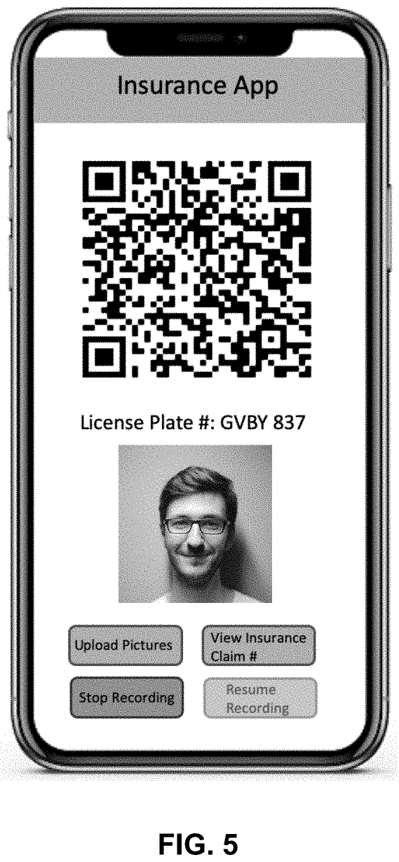

In some cases, one or more of the drivers can also associate pictures, video (with time stamps), a written account of the collision, or any other information with the unique collision claim number, such as by uploading it to the server 90. In this way, the pictures, videos, written account, and other information can be associated with the collision claim number, for example, for the benefit of the relevant insurance companies and law enforcement. FIG. 5 illustrates an example of a DCC with the option to record video and upload pictures. In some cases, audio and/or video can begin automatically recording at a specific point in the process, for example, as soon as the user selects creation of the collision certificate.

In some cases, the system 100 can be incorporated, or part of, smartphone apps disseminated by the vehicle insurance company of the driver. In some cases, the server 90 can check each driver's insurance standing (such as if it has lapsed or the driver is no longer insured) and communicate this result to the coordination module 136. The output module 138 can output to the user, via the user interface 108, the status of the other driver's insurance to instruct such driver if further steps are required; such as informing law enforcement.

While the present embodiments describe use of a QR code, it is understood that any suitable type of code could be used; for example, a barcode, a high capacity color barcode, an image for image recognition, or the like. In further cases, the encoded data can be hashed, or otherwise encrypted, and communicated to the other computing device 70, 80 via any suitable approach; for example, Bluetooth™, near-field communication (NFC), wireless local area network, or the like.

For ease of illustration, the present disclosure described a collision involving two drivers, and thus two computing devices 70 and 80, it is understood that the collision can include any number of drivers in their own vehicle and each having a separate computing device. In this way, the unique collision claim number would be jointly associated with all the drivers associated with the collision.

[Although the foregoing has been described with reference to certain specific embodiments, various modifications thereto will be apparent to those skilled in the art without departing from the spirit and scope of the invention as outlined in the appended claims.

1. A system for generating a first collision certificate associated with a vehicle collision, the system comprising one or more processors in communication with a data storage and a user interface, the system in communication with a server, the one or more processors configured to execute:
an input module to receive, from a first user involved in the vehicle collision, first public information associated with the first user and first private information associated with the first user;
a certificate module configured to generate the first collision certificate, the first collision certificate comprising the first public information and first encoded data, the first encoded data comprising at least some of the first private information, the certificate module further configured to display the first collision certificate, via the user interface, for verification;
a coordination module configured to communicate at least some information of the first collision certificate to the server and receive a unique collision claim number from the server, the unique collision claim number being associated with at least some of the information of the first collision certificate; and
an output module to output the unique collision claim number to the first user via the user interface.

2. The system of claim 1, wherein a second collision certificate is generated in association with a second user involved in the vehicle collision, the second collision certificate comprising second public information associated with the second user and second encoded data, the second encoded data comprising second private information associated with the second user,
the coordination module further configured to receive at least some information of the second collision certificate, the coordination module further configured to communicate the at least some information of the second collision certificate to the server for use in generating the unique collision claim number.

3. The system of claim 2, wherein at least one of the second public information and second private information comprises driver insurance status information associated with the second user, and wherein the system is configured to automatically check the driver insurance status and inform the first user of the driver insurance status information associated with the second user.

4. The system of claim 1, wherein the first public information comprises at least one of a license plate number of the first user's vehicle involved in the vehicle collision, a name of the first user, and a picture of the first user.

5. The system of claim 1, where in the first public information comprises a license plate number of the first user's vehicle involved in the vehicle collision and a picture of the first user.

6. The system of claim 1, wherein the first encoded data comprises at least one of a vehicle make, vehicle model, vehicle color, driver's license number, and vehicle insurance information.

7. The system of claim 1, wherein the first encoded data comprises at least two of a vehicle make, vehicle model, vehicle color, driver's license number, and vehicle insurance information.

8. The system of claim 1, wherein the coordination module is configured to display, to the first user, second public information of a second user involved in the vehicle collision, and second encoded data, the second encoded data comprising second private information of the second user.

9. The system of claim 1, wherein the coordination module is configured to receive second encoded data, the second encoded data comprising second private information of a second user associated with the vehicle collision.

10. The system of claim 1, the system operable to communicate at least some information of the first collision certificate to an entity not involved in the vehicle collision.

11. The system of claim 10, wherein the third party is at least one of a governmental agency or an insurance company associated with a driver involved in the vehicle collision.

12. The system of claim 1, wherein the input module is further configured to receive first additional collision information comprising at least one of a picture of the vehicle collision, a video, and a written account of the vehicle collision, and wherein the first additional information is uploadable to the server.

13. The system of claim 1, wherein the system automatically initiates recording of a video and or audio.

14. The system of claim 1, wherein the system is configured to automatically instruct a first user to perform at least one step based on at least some information of the first collision certificate or the second collision certificate.

15. In a system comprising one or more processors in communication with a data storage and a user interface, the system in communication with a server, the one or more processors, a method for generating a first collision certificate associated with a vehicle collision:
receiving, from a first user involved in the vehicle collision, first public information associated with the first user and first private information associated with the first user;
generating the first collision certificate, the first collision certificate comprising the first public information and first encoded data, the first encoded data comprising at least some of the first private information;
displaying the first collision certificate to the first user for verification;
communicating at least some information of the first collision certificate to the server and receiving a unique collision claim number from the server, the unique collision claim number being associated with at least some of the information of the first collision certificate; and
outputting the unique collision claim number to the first user.

16. The system of claim 15, wherein a second collision certificate is generated in association with a second user involved in the vehicle collision, the second collision certificate comprising second public information associated with the second user and second encoded data, the second encoded data comprising second private information associated with the second user,
the method further comprising receiving at least some information of the second collision certificate, and
communicating at least some information of the second collision certificate to the server for use in generating the unique collision claim number.

17. The system of claim 15, further comprising displaying, to the first user, second public information of a second user involved in the vehicle collision, and second encoded data, the second encoded data comprising second private information of the second user.

18. The system of claim 15, further comprising receiving second encoded data, the second encoded data comprising second private information of a second user associated with the vehicle collision.
